(19) United States
(12) Patent Application Publication
(10) Pub. No.: US 2023/0122450 A1
(43) Pub. Date: Apr. 20, 2023

(54) ANCHORED MESSAGES FOR AUGMENTED REALITY

(71) Applicant: Google LLC, Mountain View, CA (US)

(72) Inventors: Alex Olwal, Santa Cruz, CA (US); Ruofei Du, San Francisco, CA (US)

(21) Appl. No.: 17/451,587

(22) Filed: Oct. 20, 2021

(51) Int. Cl. G02B 27/01; G06K 9/00; G06T 7/50; G06F 3/14; G06F 3/01; G10L 17/06; H04R 1/40; H04R 3/00; G10L 17/02

(52) U.S. Cl. CPC G02B 27/0172; G06F 3/012; G06F 3/14; G06K 9/00288; G06T 7/50; G10L 17/02; G10L 17/06; H04R 1/406; H04R 3/005; G06T 2207/10028; H04B 1/69; H04R 2499/15

(57) ABSTRACT

Augmented reality devices can be configured to display messages in response to sounds from an environment. A variety of techniques can be combined to localize and track the sources of the sounds in the environment. Messages created in response to the sounds can then be anchored to their corresponding sources in order to provide a user with a clear understanding of the location of sources of the messages. Additionally, these anchored messages can be enhanced with additional information, such as identification, to further the user’s understanding of the sources of the messages. The anchored messages can track relative movement to integrate with the AR environment.

### FIELD OF THE DISCLOSURE

The present disclosure relates to augmented reality (AR) and more specifically to messages related to a sound that are spatially anchored in AR to the source of the sound.

### BACKGROUND

AR devices, such as AR glasses, can help a user understand an environment by providing the user with messages related to the environment. For example, an AR device may display a transcript to help a user hear, recognize, understand, and/or document sounds (e.g., speech, music, etc.) from an environment around the AR device (i.e., a global environment). The displayed transcript may be presented/updated in real time as sounds are emitted but may lack AR attributes that could provide a viewer with a better understanding of the environment.

### SUMMARY

In at least one aspect, the present disclosure generally describes a method for displaying a message on an augmented reality (AR) device. The method includes capturing a first sound from a first sound source and determining an identity of the first sound source. The method further includes mapping a location of the first sound source and generating a first message for the first sound. The method further includes displaying the first message at a first position on a heads-up display of the AR device, which corresponds to a location of the first sound source as seen through the heads-up display. The method further includes updating the first position of the first message on the heads-up display based on a movement of the first sound source and/or the AR device so that the first message tracks the location of the first sound source relative to the heads-up display.

In another aspect, the present disclosure generally describes AR glasses. The AR glasses include a microphone array that is configured to capture sounds from sound sources and to determine the directions of the sound sources relative to the AR glasses. The AR glasses further include a heads-up display that is configured to display messages corresponding to the sounds in a field of view of the user. The AR glasses further include an inertial measurement unit configured to measure changes in position of the AR glasses. The AR glasses further include a processor that is in communication with the microphone array, the heads-up display, and the inertial measurement unit. The processor is configured by software to perform a method. The method includes generating the messages corresponding to the sounds. The method further includes determining locations of the sound sources relative to the AR glasses based, at least, on the directions of the sound sources. The method further includes displaying the messages on the heads-up display at positions in the field of view corresponding to the locations of the sound sources. The method further includes tracking relative movement of the AR glasses and the sound sources based, at least, on the changes in position of the AR glasses. The method further includes updating the positions of the messages as the sound sources or the AR glasses are moved so that each message is virtually anchored to its corresponding sound source.

In another aspect, the present disclosure generally describes a method for AR transcription that includes transcribing sounds from sound sources in a global environment. The method further includes applying sound localization to determine directions for the sounds from the global environment. The method further includes applying source localization to determine precise locations of the sound sources in the global environment. The method further includes generating a source transcript for each sound based on the directions and the precise locations and anchoring each source transcript so that it appears with a corresponding sound source when viewed through an augmented reality display. The method further includes tracking each sound source in the global environment and updating a source transcript based on a relative movement of the corresponding sound source.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is a flowchart of a method for creating an anchored sound message for augmented reality according to a possible implementation of the present disclosure.

FIG. 2 is a perspective view of AR glasses according to a possible implementation of the present disclosure.

FIG. 3 is a top view of the AR glasses of FIG. 2 in a global environment with sound sources.

FIG. 4 is a system block diagram of AR glasses according to a possible implementation of the present disclosure.

FIG. 5 illustrates the plurality of processes that can be used to enhance messages related to sound in an AR environment according to a possible implementation of the present disclosure.

FIG. 6 illustrates a message before and after enhancement according to a possible implementation of the present disclosure.

FIG. 7 is a flowchart of a method for displaying a message on an AR device according to an implementation of the present disclosure.

FIG. 8 is a flowchart of a method for anchoring a message to a sound source in various operating conditions according to an implementation of the present disclosure.

FIG. 9 illustrates a possible computing environment suitable for implementing the disclosed techniques.

The components in the drawings are not necessarily to scale relative to each other. Like reference numerals designate corresponding parts throughout the several views.

### DETAILED DESCRIPTION

AR devices can be configured to display messages in response to sounds from an environment. For example, a user wearing AR glasses may view a transcript (or translation) of speech. The speech may be generated by people (i.e., speakers) positioned at different locations in the environment. All speakers may be included in a single transcript, which may make identifying each speaker difficult, especially for a hearing-impaired user.

Understanding the relative locations of the sounds in the global environment may also be difficult when a message is presented with no spatial information regarding the sources of the sounds. For example, a user may have difficulty assigning a portion of a speech-to-text transcript to a particular speaker when the transcript is presented with no spatial queues. For example, a transcript displayed at a fixed position on an AR display (i.e., heads-up display), or a transcript displayed as a virtual element at a fixed position in an AR environment (i.e., cloud anchor), do not aid a user in locating the speaker. Visually locating a sound source may be especially helpful to a hearing-impaired user.

The present disclosure describes systems and methods to solve the technical problems described above by enhancing how messages related to sound are generated and displayed in an AR environment. The enhanced messages may have the technical effect of conveying location and identity information corresponding to sound sources to a user without requiring effort on the part of the user (i.e., automatically). This may advantageously improve the user’s experience in the AR environment.

Enhanced messages can be messages anchored to a source of the sound that created the message. For example, a speech-to-text transcript (i.e., transcript) may be anchored to a person speaking. For example, the transcript may appear next to a face of a person and may remain next to the face of the person even as a relative position of the person changes.

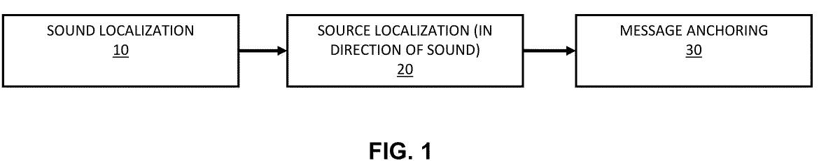

FIG. 1 is a flowchart of a method for anchoring a sound message (e.g., anchored transcript) according to a possible implementation of the present disclosure. Anchoring the sound message (i.e., message) may include determining a direction from which a sound originates (i.e., sound localization 10). The sound localization 10 may be accomplished using an array of microphones and can return a direction of the sound relative to the AR device. The results of the sound localization 10 (i.e., a direction) may be used to roughly locate where a transcript should be displayed in the AR environment. In some cases, (e.g., low power mode of operation) the direction information is sufficient for anchoring the transcript; however, more accurate location information may create a more desirable experience for a user. Accordingly, in some situations (e.g., not low power mode), the sound localization 10 may be combined with other localization techniques to determine a more accurate position of the source of sound.

The method for anchoring the sound message can include locating the source of the sound (i.e., source localization 20) using additional means, and possibly more accurate means, for locating. For example, the source localization 20 can include scanning for a sound source (i.e., source) in images from the direction of the sound. If a source is found in the direction of the sound, then the location of the source can be determined with a higher degree of accuracy. For example, the source localization may return coordinates (x, y, z) of the sound source in the environment.

Various locating means may be used for source localization 20, where the precise means and/or combination of means may be determined based on the sound source. For example, locating a human speaker may include recognizing the person’s face in the direction of the sound. In another example, locating a smart device may include mapping an indoor position of the smart device using network communication. In another example, locating a sound source may include capturing a depth image of a scene. Any or all of these means may be applied to determine a precise location of the sound source in the direction of the sound. Further, the choice of means may be based on a processing and power budget available to the AR device at the time of the localization.

The method for anchoring the sound message can include linking the message to the location of the sound source (i.e., message anchoring 30). The message anchoring 30 may include generating a virtual bounding box in the AR environment and then anchoring the message to a point on the virtual bounding box (i.e., bounding box). Determining the bounding box may include estimating a size of the sound source and generating a bounding box to contain the size. The bounding box may be configured to move with the relative position of the sound source. Accordingly, anchoring the message to the bounding box may allow the message to track the relative position of the sound source. The anchored message may persist anchored to the sound source for a time before disappearing.

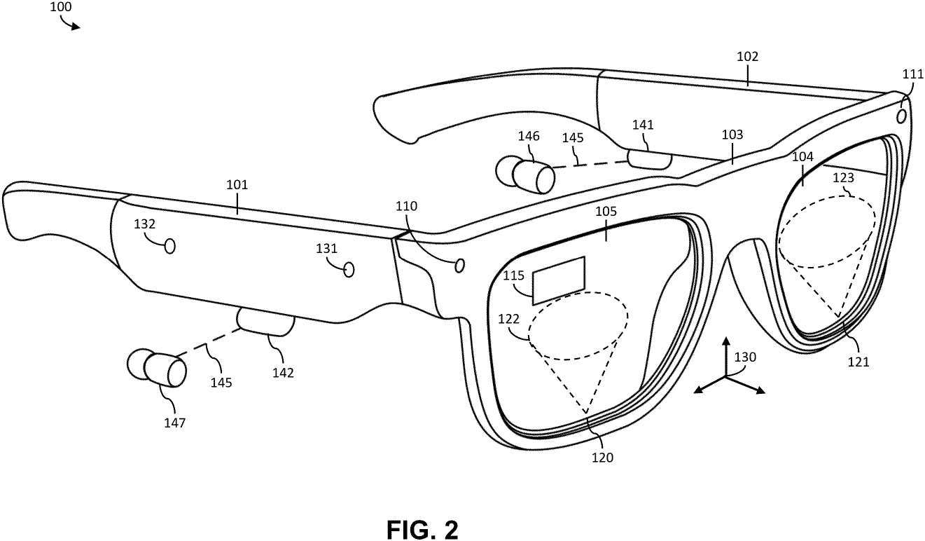

The method mentioned above may be carried out on an AR device, such as the AR glasses shown in FIG. 2. FIG. 2 is a perspective view of AR glasses according to a possible implementation of the present disclosure. The AR glasses 100 are configured to be worn on a head and face of a user. The AR glasses 100 include a right earpiece 101 and a left earpiece 102 that are supported by the ears of a user. The AR glasses further include a bridge portion 103 that is supported by the nose of the user so that a left lens 104 and a right lens 105 can be positioned in front a left eye of the user and a right eye of the user respectively. The portions of the AR glasses can be collectively referred to as the frame of the AR glasses. The frame of the AR glasses can contain electronics to enable function. For example, the frame may include a battery, a processor, a memory (e.g., non-transitory computer readable medium), and electronics to support sensors (e.g., cameras, depth sensors, etc.), and interface devices (e.g., speakers, display, network adapter, etc.).

A user wearing the AR glasses can experience information displayed within the lens (or lenses) so that the user can view virtual elements within their natural field of view. Accordingly, the AR glasses 100 can further include a heads-up display (i.e., AR display) configured to display visual information at a lens (or lenses) of the AR glasses. As shown, the heads-up display may present AR data (e.g., images, graphics, text, icons, etc.) on a portion 115 of a lens (or lenses) of the AR glasses so that a user may view the AR data as the user looks through a lens of the AR glasses. In this way, the AR data can overlap with the user’s view of the environment. The portion 115 may include part or all of a lens (or lenses) of the AR glasses.

When viewed on the AR glasses, a virtual element can be anchored (i.e., placed) at a particular location in a global (i.e., real) environment so that it appears at the particular location whenever the particular location is within the natural field of view of the user. In other words, the anchored virtual element can appear like a real element placed at the particular location to a user wearing the AR glasses. The disclosed approach enhances messages by anchoring them to either fixed or movable objects (e.g., a person). In this way, the anchored messages may appear as movable anchors.

The AR glasses 100 can include a FOV camera 110 (e.g., RGB camera) that is directed to a camera field-of-view that overlaps with the natural field-of-view of the user’s eyes when the glasses are worn. In a possible implementation, the AR glasses can further include a depth sensor 111 (e.g., LIDAR, structured light, time-of-flight, depth camera) that is directed to a depth-sensor field-of-view that overlaps with the natural field-of-view of the user’s eyes when the glasses are worn. Data from the depth sensor 111 and/or the FOV camera 110 can be used to measure depths in a field-of-view (i.e., region of interest) of the user (i.e., wearer). In a possible implementation, the camera field-of-view and the depth-sensor field-of-view may be calibrated so that depths (i.e., ranges) of objects in images from the FOV camera 110 can be determined in depth images, where pixel values correspond with depths measured at positions corresponding to the pixel positions.

The AR glasses 100 can further include an eye-tracking sensor. The eye tracking sensor can include a right-eye camera 120 and a left-eye camera 121. The right-eye camera 120 and the left-eye camera 121 can be located in lens portions of the frame so that a right FOV 122 of the right-eye camera includes the right eye of the user and a left FOV 123 of the left-eye camera includes the left eye of the user when the AR glasses are worn.

The AR glasses 100 can further include a plurality of microphones (e.g., 4 microphones). The plurality of microphones can be spaced apart on the frames of the AR glasses. As shown in FIG. 2, the plurality of microphones can include a first microphone 131 and a second microphone 132. The plurality of microphones may be configured to operate together as a microphone array. The microphone array can be configured to apply sound localization to determine directions of the sounds relative to the AR glasses.

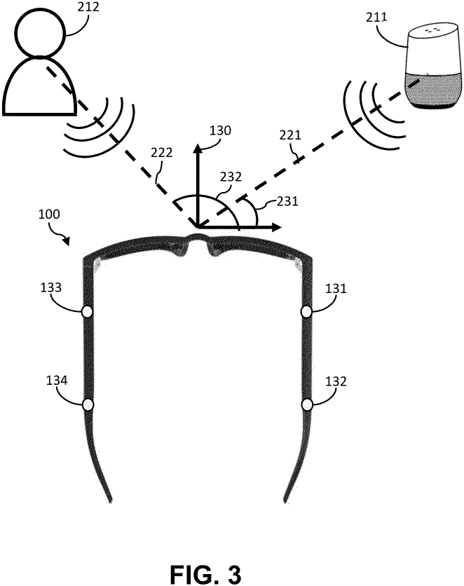

FIG. 3 is a top view of the AR glasses 100. In this example implementation, the microphone array includes the first microphone 131, the second microphone 132, a third microphone 133 and a fourth microphone 134. The microphones may be arranged in a variety of possible microphone array layouts (i.e., configurations). As shown, one possible array of microphones (i.e., microphone array) includes a left pair of microphones 133, 134 and a right pair of microphones 131, 132.

The microphone array may be configured to localize sounds to determine sound directions relative to the AR glasses. As shown, the global environment includes a first sound source 211 (e.g., smart speaker) and a second sound source 212 (e.g., a person speaking). In a possible implementation, times of arrivals of the sounds at the microphones in the microphone array may help determine that the first sound source 211 is located along a first direction 221 defined by a first angle 231 with the AR glasses (i.e., with a coordinate system 130 of the AR glasses). Likewise, times of arrivals of the sounds at the microphones in the microphone array may help determine that the second sound source 212 is located along a second direction 222 defined by a second angle 232 with the AR glasses.

As shown in FIG. 2, the AR glasses may further include a left speaker 141 and a right speaker 142 configured to transmit audio (e.g., beamformed audio) to the user. Additionally, or alternatively, transmitting audio to a user may include transmitting the audio over a wireless communication link 145 to a listening device (e.g., hearing aid, earbud, etc.). For example, the AR glasses may transmit audio (e.g., beamformed audio) to a left wireless earbud 146 and to a right earbud 147.

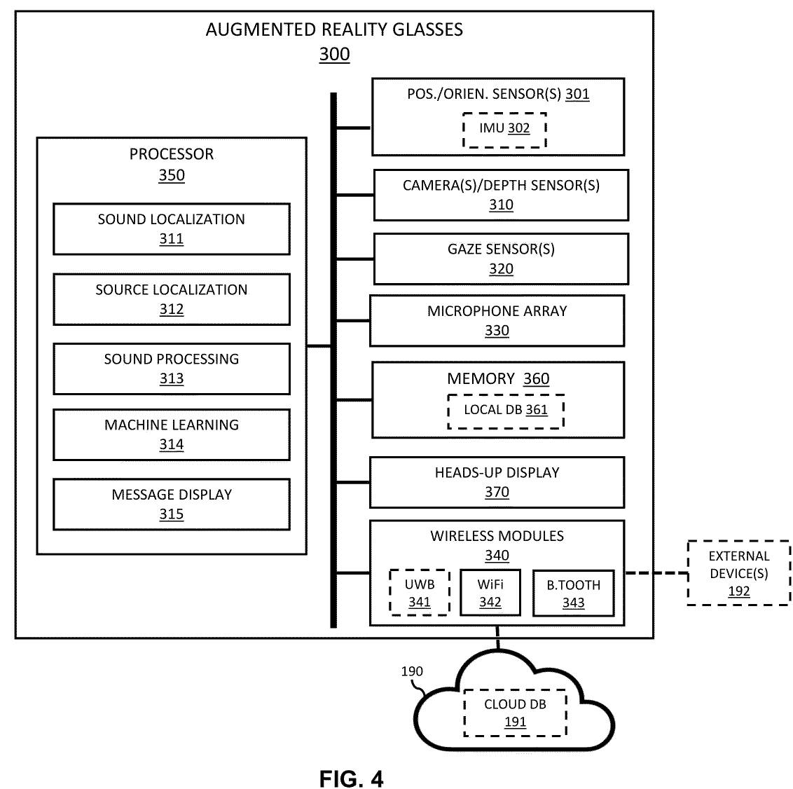

The disclosed approach may include collecting data from a plurality of sensors that operate on AR glasses to provide the augmented reality. FIG. 3 illustrates a system block diagram of the AR glasses according to a possible implementation. As shown, the AR glasses 300 can include position/orientation sensor(s) 301 configured to detect the position/orientation of the AR glasses relative to a global coordinate system. For example, the position/orientation sensors(s) 301 may include an inertial measurement unit (IMU 302). The IMU 302 may include accelerometers to measure velocity and/or acceleration, gyroscopes to measure rotation and/or rotational rate, and/or magnetometers to establish a direction of movement. Data from these sensors can be combined to track the relative position/orientation of the AR glasses. As shown in FIG. 4, the AR glasses 300 can further include camera(s) and/or depth sensor(s) 310 directed to a field of view that overlaps with a user’s natural field of view. As described previously, the camera(s) may include a camera configured to capture visual (i.e., RGB) images of the field of view (FOV) and a camera (e.g., depth sensor) configured to capture depth images of the FOV. The positioning data from the IMU 302 and the images from the camera(s) 310 may be used in a simultaneous localization and mapping (SLAM) process configured to track the position of the AR glasses 300 relative to a global environment. For example, the SLAM process can identify feature points in images captured by the camera(s) 310. The feature points can be combined with the IMU data to estimate a pose (i.e., position/orientation) of the AR glasses 300 relative to a global environment.

The AR glasses 300 can further include sensors to estimate positions (i.e., point locations, x,y,z) of objects, devices, people, animals, etc. around the user. As shown in FIG. 4, the AR glasses 300 can further include gaze sensor(s) 320 (e.g., eye-directed camera(s)) configured to sense attributes (e.g., pupil position) of an eye (or eyes) of a user. The attributes may be processed to determine a direction or point at which a user is looking (i.e., a gaze of the user). When the gaze of the user is combined with the pose of the user, an interaction between the user and the environment may be understood. For example, data from gaze sensors may be used to help determine the direction and/or position of a device or person in the global environment.

As shown in FIG. 4, the AR glasses 300 can further include a microphone array 330 configured to sense sounds from an environment. Further, the microphone array 330 may be configured to determine directions of sounds from an environment, as shown in FIG. 4. Data from the microphone array may be used to help determine the direction and/or position of a device or person in the global environment.

The AR glasses 300 can further include wireless modules 340. The wireless modules may include various circuits (i.e., modules) configured to communicate in a variety of wireless protocols. For example, the wireless module may include ultra-wideband (UWB) module 341, a wifi module 342, and/or a Bluetooth module 343. The wireless modules 340 may be configured to wireless couple the AR glasses 300 to external device(s) 192 and/or to a network 190 (i.e., cloud) in order to exchange data. For example, the external device(s) 192 can include a mobile computing device (e.g., mobile telephone) that, through a wireless communication link, can help process data from the AR glasses. In another example, the network 190 can include a cloud database 191 that, through a wiles communication link, can help store and retrieve data with the AR glasses. The wireless modules may also be able to determine a position of the AR device relative to an external device. For example, an UWB module 341 may be able to determine a relative range between two devices using a round trip time (RTT) of a signal in a communication between the two devices. Further, when the UWB module includes an array of receivers, a relative direction between the two devices may be determined based on a time of arrival of the signal at the receivers. Accordingly, data from the wireless modules 340 may be used to help determine the direction and/or position of a device or person in the global environment.

The AR glasses 300 further includes a processor 350 that can be configured by software to perform a plurality of processes (i.e., a pipeline) required for augmented reality. The plurality of processes can include sound localization 311, source localization 312, sound processing 313, machine learning 314, and message display 315. The plurality of processes may be embodied as programs stored in (and retrieved from) a memory 360. The disclosed approach can combine data and/or functions from these processes to provide anchored messages for presentation on a heads-up display 370 of the augmented reality glasses 300.

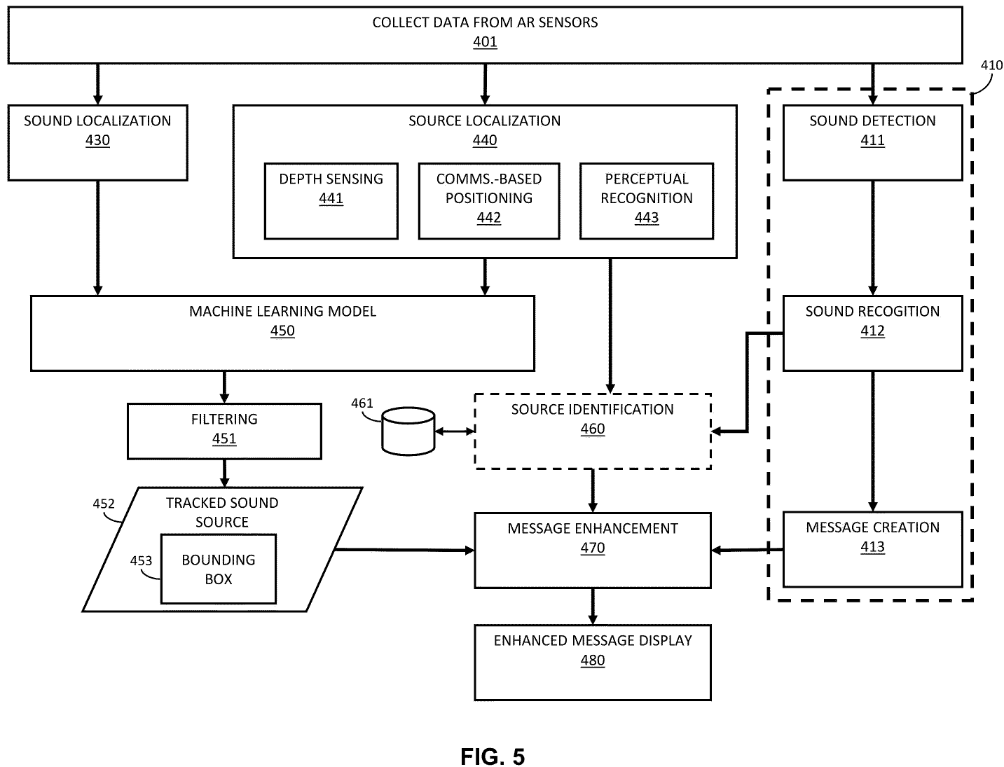

FIG. 5 illustrates a flow chart of the plurality of processes that can be used to enhance messages corresponding to sounds in an AR environment according to a possible implementation of the present disclosure. The plurality of processes can use data collected 401 from the plurality of sensors on the AR glasses (i.e., AR sensors) to enhance messages associated with sound. As previously described, the AR sensors can include (but are not limited to) an IMU, a depth sensor, a camera, a microphone array, and a wireless module configured for positioning.

The plurality of processes can include sound processing 410 configured to receive audio signals collected by a microphone (e.g., the microphone array). The speech processing can include a sound detection process 411 configured to detect that a sound has occurred in the environment. The speech processing 410 can further include a sound recognition process 412 that can determine what type of sound has been detected. The sounds may include a human voice (e.g., speech). The sounds may also include a loudspeaker sound from a device. For example, the loudspeaker sound may be a sound (e.g., voice) from a digital assistant, a robot (e.g., telepresence robot), a smart display (e.g., video conference display), or a mobile phone (e.g., ringtone). The sounds can further include an animal sound (e.g., barking) or any other environment sound (e.g., car honk, alarm, doorbell, etc.). The recognition process may be configured to classify the sounds accordingly so that a message creation process 413 can create a message corresponding to the recognized sound. For example, a sound may be detected as speech and the message creation process 413 may include generating a speech-to-text transcript of the speech. In another example, a sound may be detected as speech from a first language and the message creation process 413 may include generating a speech-to-text transcript that includes a translation of the first language to a second language. In some cases, the message may include a graphic or an image. The messages generated by the message creation process 413 may not have any identifying or localizing information. Accordingly, the plurality of processes further includes added processes to locate and (in some cases) identify a source of the sound (i.e., sound source).

The plurality of processes can further include sound localization 430 for determining directions of sounds relative to the AR device in the global environment. The plurality of processes can further include mapping a location of (i.e., localizing) a sound source. The sound localization 430 can include determining a direction of a sound from data collected by the microphone array. In a possible implementation, this determination may be aided by determining a gaze of a user. For example, the determination of the sound direction may be qualified by a confidence that is based (at least in part) on the gaze of a user. While the sound localization process can separate sound sources in an environment (e.g., by direction), the localization (i.e., mapping) can, in some implementations, be made more accurate with further localization data corresponding to the source.

The plurality of processes can further include source localization 440 configured to sense data related to a position of a sound source in the environment. The source localization 440 can include depth sensing 441, which can include measuring a range between a sound source and the AR glasses. The range may be measured using a variety of techniques, including (but not limited to) depth imaging, lidar, structured light, and ultrasound. The range may help locate a source by determining the range to the source at a direction of the sound.

The source localization process 440 can further include communications-based positioning 442. The communications-based positioning 442 may include determining a spatial relationship between a sound source and the AR device through wireless communication. For example, measurements (e.g., round-trip times, time of arrival) related to UWB or Bluetooth communication between the AR glasses and an external device (e.g., smart device) can be used to determine a range and, in some implementations, an angle between the devices. Further, in some implementations the location of a smart device may be reported (e.g., over WiFi) to the AR glasses. For example, a device may identify itself on a network via a network identifier.

The source localization process 440 can further include perceptual recognition 443. The perceptual recognition 443 can be configured to recognize visual attributes of real objects in the global environment or visual attributes of virtual objects in the AR environment. For example, the perceptual recognition 443 may include recognizing a face. In a possible implementation, images captured by the AR glasses may be analyzed to detect a face at (or near) the direction of the sound source to help localize the sound source. The perceptual recognition 443 may also include recognizing a cloud anchor. A cloud anchor is a virtual object that is fixed in a location in an AR environment so a viewer can view it as if it were a real object. A cloud anchor may be used to identify a sound source. In a possible implementation, the cloud anchor may identify a device with no connectivity. For example, a cloud anchor may be created at a doorbell location to identify the doorbell as a sound source. The perceptual recognition 443 may recognize and localize the doorbell based on the cloud anchor. In a possible implementation, the perceptual recognition may be configured to recognize combined visual and sound attributes of a sound source to help localization. For example, the perceptual recognition may recognize a barking sound with a captured image of a dog, a ringtone sound with a captured image of a phone, or a honking sound with a captured image of a car.

Data from the sound localization 430 and the source localization 440 can be combined as inputs to a machine learning model 450 (e.g., neural network). In some implementations these inputs can be further combined with the position/orientation (e.g., SLAM data) of the AR glasses. Based on the inputs, the machine learning model is trained to localize the sound source at a particular location in the global environment relative to the AR glasses. Further, the inputs to machine learning model 450 may be continuously updated to track the localized sound source as it moves. In other words, the machine learning model 450 may output a tracked sound source 452. The tracked sound source may be implemented as a virtual element positioned in the AR environment with the sound source. For example, a (virtual) bounding box 453 may be generated to define boundaries of the sound source in the AR environment according to the position of the localized sound source in the global (i.e., real) environment. For example, when a person is identified as a sound source, a bounding box 453 may be created to frame the face of the person and to track the face as the person (or the AR glasses) move. The bounding box may be displayed or not displayed in the AR environment (i.e., to a user). In a possible implementation the location of the bounding box may be applied to a filtering process 451 (e.g., Kalman filter, One Euro filter) to prevent jitter (i.e., noise) in the position of the bounding box 453 over time. A message can be anchored to the bounding box. As a result, the filtering 451 may prevent jitter in the relative position of the anchored message in the AR display.

In a possible implementation, the plurality of processes can optionally include a source identification process 460 configured to identify a sounds source based on data from the perceptual recognition 443 (e.g., face image) and/or the sound recognition 412 (e.g., voice print). The data may be applied to a classifier trained on previously identified data (e.g., familiar faces) recorded in a local database 361 stored in a memory 360 of the AR glasses or in a cloud database 191 stored in a cloud database 191 connected to the AR glasses via a network 190. For example, the source identification 460 may compare a face or a voice print to a database 461 of familiar faces and/or familiar voiceprints to identify a person (e.g., by name).

The plurality of processes includes message enhancement 470. The message enhancement can be configured to modify the message from the sound processing 410 according to the localized sound source (e.g., bounding box 453) and (optionally) according to the identity of the sound source. For example, the message enhancement may include anchoring (e.g., attaching) the message to the bounding box 453 of the sound source so that when the message is displayed in the AR environment it appears next to the sound source for the message. For example, a speech-to-text transcript (i.e., source transcript) can be positioned next to (but not covering) a face of a speaking person. When multiple sound sources are localized, the message enhancement may include creating separate messages for each sound source and then anchoring each message to its corresponding sound source. While the message creation 413 and the message enhancement 470 have been discussed as discrete processes to help explain the disclosed approach, it should be noted that variations to these processes are possible. For example, it may be possible to generate enhanced messages (e.g., anchored and identified) for each sound source in one process. Further, it may be possible for the message creation process 413 to include identifying portions of the message corresponding to different sound sources before the enhancement occurs. These possible variations, as well as others, are within the scope of the disclosed approach.

The message enhancement 470 can include changing an attribute of a message and/or adding content to a message. For example, an enhanced message may be colored and/or styled according to its sound source. For example, a transcript from a particular person or device may have a font color/style that is different from other transcripts. An enhanced message may be sized according to its location. For example, a transcript from a distant speaker may have a font size that is different from a close speaker. An enhanced message may include an identifier for its corresponding sound source. For example, a transcript may include a speaker’s name or a device identifier. An enhanced message may include a timestamp to provide a viewer with an idea of when the message was created. An enhanced message may include a visual cue to provide a viewer with an idea of where the sound source is located. For example, a sound source that is out of the field of view may include an arrow indicating a direction to the source of a sound. For example, a ringing phone or doorbell may generate a message that includes arrows to guide a user’s view to the phone or door. Variations and possible combinations of these examples are all within the scope of the disclosed approach. After message enhancement the anchored message may be displayed on an AR display of the AR glasses. Accordingly, the plurality of processes includes enhanced message display 480.

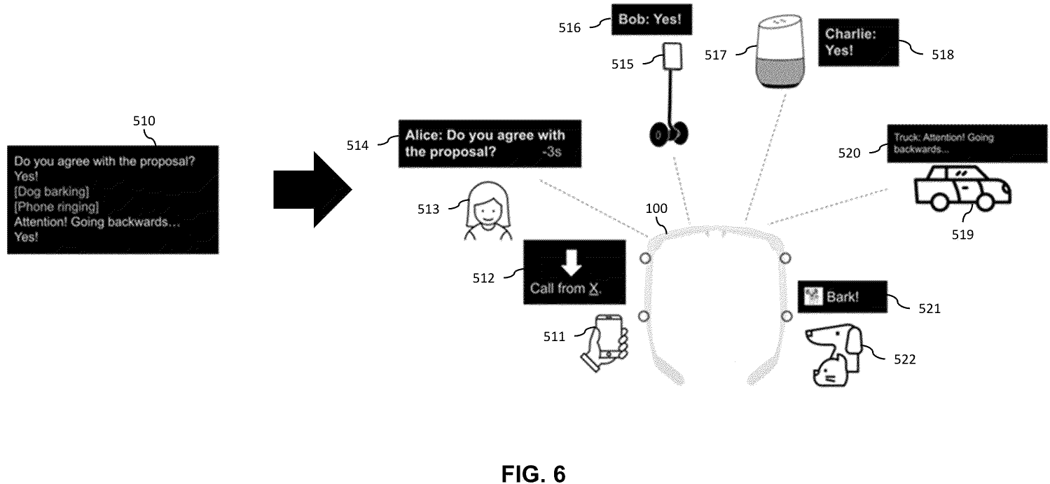

FIG. 6 illustrates a message before and after message enhancement 470 according to a possible implementation of the present disclosure. Before enhancement, a message may be a single transcript 510 that includes messages for all of the sound sources in the environment. The messages include transcribed speech (i.e., “do you agree with the proposal?”, “Yes!”, “Yes!”) as well as transcribed sounds (i.e., dog barking, phone ringing). The single transcript 510 may be enhanced to provide additional information and integrate with augmented reality according to the plurality of processes described previously. After enhancement, the messages in the transcript are separated as source messages and arranged spatially with their corresponding sound source in the AR environment. Each source message is configured to track movement with the sound source so as a relative position between the sound source and the AR glasses 100 change, the message stays adjacent to its sound source. As shown, the field of view in the AR environment includes a first source message 512 virtually anchored (i.e., anchored) to a mobile phone 511. The first source message 512 includes a directional cue (arrow) and caller ID information. The AR environment further includes a second source message 514 anchored to a person 513. The second source message 514 includes a name of the person and speech-to-text that is color coded according to the person. The second source message 514 further includes a relative or absolute timestamp (e.g., -3 s or 10:29:20 am). The AR environment further includes a third source message 516 anchored to a telepresence robot 515. The third source message 516 includes a name of the person and speech-to-text that is color coded according to the person. The AR environment further includes a fourth source message 518 anchored to a smart speaker 517. The fourth source message 518 includes a name of the person and speech-to-text that is color coded according to the person. The AR environment further includes a fifth source message 520 anchored to a truck 519. The fifth source message 520 includes an alert (i.e., attention!) with description of the recognized sound (i.e., going backwards) and an identifier describing the sound source (i.e., truck). The text of the fifth source message 520 is sized according to the distance of the truck 519. The AR environment further includes a sixth source message 521 anchored to a dog 522. The sixth source message 521 includes a description of the recognized sound (i.e., Bark!) and an image of the dog 521 to identify the dog 522.

As the number of source messages displayed increases, anchoring each message to its corresponding sound source may be impossible without overlap. Accordingly, the enhanced message display 480 process may further include adjusting a size and/or position of the source messages to prevent overlap or otherwise improve appearance. For example, the enhanced message display 480 may include maximal Poisson-disk sampling to arrange the source message to prevent visual clutter in the AR environment.

The disclosed approach can be applied to render a clear view of transcription / sound events / live translation near the object / human / animals that produce the speech or sound. The disclosed approach combines the localization of sounds with other localization methods to create anchored messages that can be rendered by distributing specific transcripts or sound events to locations near the object in the AR environment.

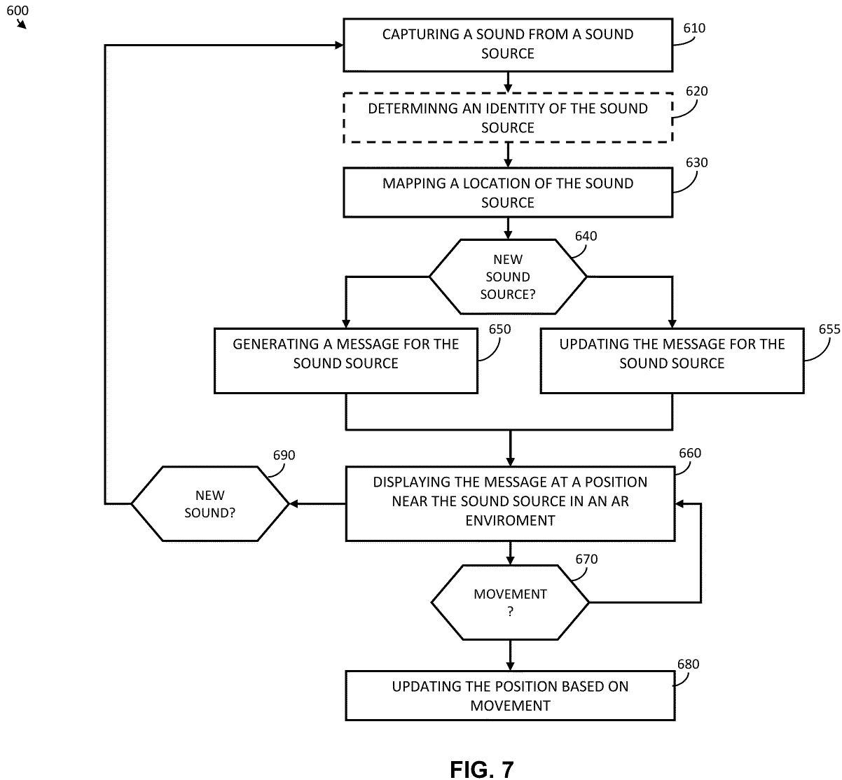

FIG. 7 is a flowchart of a method for displaying a message on an AR device (e.g., AR glasses) according to an implementation of the present disclosure. The method 600 includes capturing 610 (i.e., recording, sensing) a sound from a sound source. The sound can be captured using a microphone on the AR device. For example, the sound may be captured by a microphone array on the AR device.

The method 600 may optionally include determining 620 an identity of the sound source. For people, the AR device may identify the sound source based on an image of a face of the sound source or a voiceprint of the sound source. For devices, the AR device may identify the sound source based on an identifier communicating over a network. For objects without connectivity the AR device may identify the sound source based on a cloud anchor or based on an image of the object.

The method 600 further includes mapping 630 a location of (i.e., localizing) the sound source. The localizing may include sound localization in which an array of microphones can determine a direction of the sound combined with other source localization methods (e.g., depth sensing, comms. based positioning, perceptual recognition). All sources of localization may serve as inputs to a machine learning model that can map the location of the sound source.

The method 600 further includes generating 650 a message for newly mapped (i.e., localized) sound sources or updating 655 a message for a previously mapped sound source. Accordingly, the method may include determining if the sound source is new 640 to the AR environment. As described previously, generating the message may include translating or transcribing speech.

The method 600 further includes displaying 660 the message at a position near the sound source in an AR environment. For example, the message may be positioned at a boundary box surrounding the outer edges of the sound source. The spacing between the message and the sound source is made to convey a visual association between the message and the sound source. For example, when multiple sound sources are in a field of view the message may be displayed closest to its corresponding sound source. While the content of the message may be updated when a new sound is detected 690, the position of the message may remain fixed as long as there is no movement of the sound source in a field of view of the AR device.

The method 600 further includes updating 680 the position of the message based on a detected movement 670 of the sound source within a field of view of the AR device. The movement may be caused by a movement of the sound source, a movement of the AR device, or both. The movement may be detected by an IMU and/or camera of the device. Updating the position of the message can keep the message spatially linked (i.e., anchored) with the sound source so that it appears with the sound source whenever the sound source is in the field of view of the AR device.

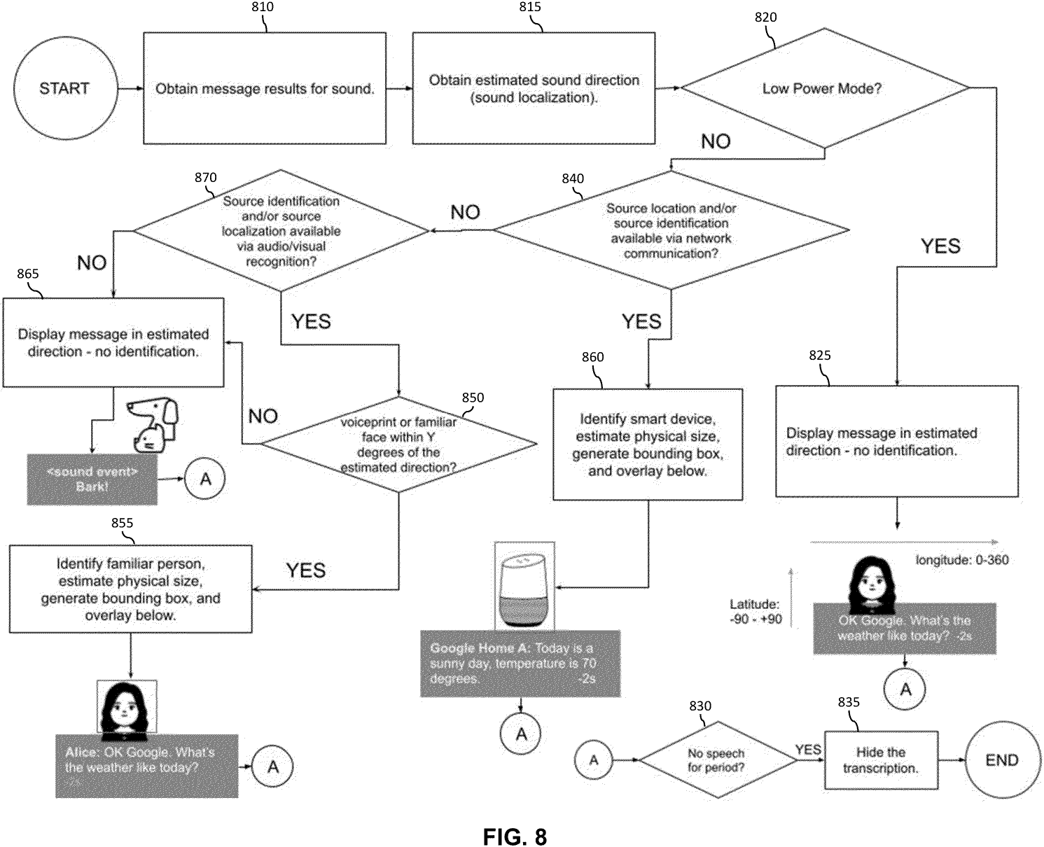

FIG. 8 is a flowchart of a method for anchoring a message to a sound source in various operating conditions according to an implementation of the present disclosure. The method includes obtaining 810 a message corresponding to a sound, such as text-from-speech results or a sound event name. The message may be obtained from a local machine-learning model or a cloud-based engine configured for sound detection/analysis. The method further includes estimating a direction of the sound (i.e., sound localization 815). In one possible implementation, the estimated direction may be an angle in one dimension (e.g., 0 ≤θ ≤360) with respect to the coordinate system of the device. In another possible implementation, the estimated direction may be latitude/longitude angles in two dimensions (e.g., 0 ≤θ ≤360, -90 ≤ ϕ≤90) with respect to the coordinate system of the device.

The method further includes determining a power mode of the device. If the device is in a low-power mode 820 (e.g., ≤20% of battery capacity), then the message may be displayed 825 in the estimated direction without (more accurate) source localization/identification. For example, a transcript may be presented in the estimated direction as an overlay 825 (e.g., partially transparent) on the sound source. No identification is included in the message and the message may persist for a period before disappearing from the AR display. For example, if there is no speech for a period 830 (e.g., 2 seconds), then the transcript may be hidden 835 and the method ends.

If the device is not in a low-power mode, then source localization and/or source identification may be performed. For example, if the device is in a high-power mode (e.g., ≥ 80% of battery capacity) and/or if the device is connected to a power source (i.e., plugged in), then source localization may be performed via network communication. If the source localization and/or source identification is available via network communication 840, then a smart device may be identified, a physical size of the smart device may be estimated, a bounding box to contain the smart device may be generated, and the message may be overlaid (and anchored) below the bounding box 860. If there is no additional sound from the smart device for a period (e.g., 2 seconds), then the message may be hidden.

If the device is not in a low-power mode and the source localization and/or source identification is not available via network communication 840, then source identification and/or source location may be performed via audio/visual recognition 870. If the device is configured for audio/visual recognition, then a voice print or familiar face may be searched for in a range of angles around (e.g., within 10 degrees) the estimated direction. If a familiar face is recognized 850 in the range of angles, then the method may include identifying the person, estimated the physical size of the person (e.g., face), generating a bounding box around the person (e.g., face), and overlaying (and anchoring) the message below the bounding box 855 (e.g., with the person’s recognized name). On the other hand, if a familiar face is not recognized 850 then the message may be displayed in the estimated direction with no identification 865. Likewise, if the device is not configured or unable to perform audio/visual recognition, then the message may be displayed in the estimated direction with no identification 865. As before if there is no additional sound for a period (e.g., 2 seconds), then the message may be hidden.

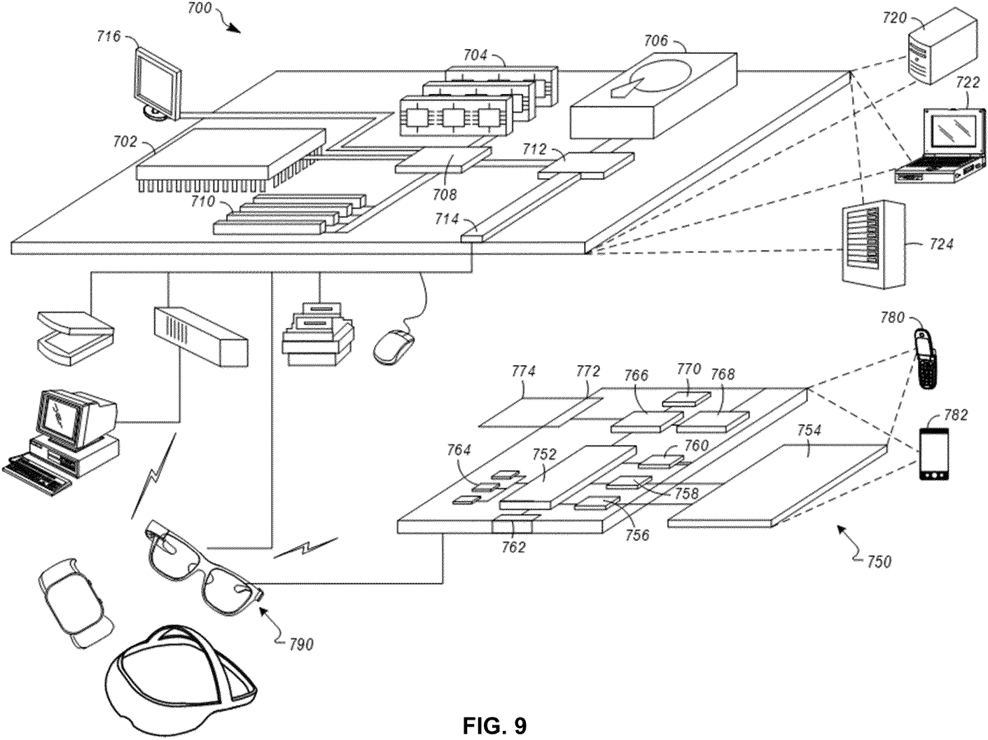

FIG. 9 illustrates an example of a computer device 700 and a mobile computer device 750, which may be used with the techniques described here (e.g., to implement the augmented reality device). The computing device 700 includes a processor 702, memory 704, a storage device 706, a high-speed interface 708 connecting to memory 704 and high-speed expansion ports 710, and a low-speed interface 712 connecting to low-speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high-speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high-speed controller 708 manages bandwidth-intensive operations for the computing device 700, while the low-speed controller 712 manages lower bandwidth-intensive operations. Such allocation of functions is an example only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display), an LED (Light Emitting Diode) or an OLED (Organic Light Emitting Diode) display, or other appropriate display technology. The display interface 756 may include appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In-Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752, that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, Wi-Fi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in the figure can include sensors that interface with an AR headset/HMD device 790 to generate an augmented environment for viewing inserted content within the physical space. For example, one or more sensors included on a computing device 750 or other computing device depicted in the figure, can provide input to the AR headset 790 or in general, provide input to an AR space. The sensors can include, but are not limited to, a touchscreen, accelerometers, gyroscopes, pressure sensors, biometric sensors, temperature sensors, humidity sensors, and ambient light sensors. The computing device 750 can use the sensors to determine an absolute position and/or a detected rotation of the computing device in the AR space that can then be used as input to the AR space. For example, the computing device 750 may be incorporated into the AR space as a virtual object, such as a controller, a laser pointer, a keyboard, a weapon, etc. Positioning of the computing device/virtual object by the user when incorporated into the AR space can allow the user to position the computing device so as to view the virtual object in certain manners in the AR space. For example, if the virtual object represents a laser pointer, the user can manipulate the computing device as if it were an actual laser pointer. The user can move the computing device left and right, up and down, in a circle, etc., and use the device in a similar fashion to using a laser pointer. In some implementations, the user can aim at a target location using a virtual laser pointer.

In some implementations, one or more input devices included on, or connect to, the computing device 750 can be used as input to the AR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 750 when the computing device is incorporated into the AR space can cause a particular action to occur in the AR space.

In some implementations, a touchscreen of the computing device 750 can be rendered as a touchpad in AR space. A user can interact with the touchscreen of the computing device 750. The interactions are rendered, in AR headset 790 for example, as movements on the rendered touchpad in the AR space. The rendered movements can control virtual objects in the AR space.

In some implementations, one or more output devices included on the computing device 750 can provide output and/or feedback to a user of the AR headset 790 in the AR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 750 may appear as another object in a computer-generated, 3D environment. Interactions by the user with the computing device 750 (e.g., rotating, shaking, touching a touchscreen, swiping a finger across a touch screen) can be interpreted as interactions with the object in the AR space. In the example of the laser pointer in an AR space, the computing device 750 appears as a virtual laser pointer in the computer-generated, 3D environment. As the user manipulates the computing device 750, the user in the AR space sees movement of the laser pointer. The user receives feedback from interactions with the computing device 750 in the AR environment on the computing device 750 or on the AR headset 790. The user’s interactions with the computing device may be translated to interactions with a user interface generated in the AR environment for a controllable device.

In some implementations, a computing device 750 may include a touchscreen. For example, a user can interact with the touchscreen to interact with a user interface for a controllable device. For example, the touchscreen may include user interface elements such as sliders that can control properties of the controllable device.

Computing device 700 is intended to represent various forms of digital computers and devices, including, but not limited to laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be examples only, and are not meant to limit implementations of the inventions described and/or claimed in this document.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Further to the descriptions above, a user may be provided with controls allowing the user to make an election as to both if and when systems, programs, or features described herein may enable collection of user information (e.g., information about a user’s social network, social actions, or activities, profession, a user’s preferences, or a user’s current location), and if the user is sent content or communications from a server. In addition, certain data may be treated in one or more ways before it is stored or used, so that personally identifiable information is removed. For example, a user’s identity may be treated so that no personally identifiable information can be determined for the user, or a user’s geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or subcombinations of the functions, components and/or features of the different implementations described.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

1. A method for displaying a message on an augmented reality (AR) device, the method comprising:
capturing a first sound from a first sound source;
determining an identity of the first sound source;
mapping a location of the first sound source;
generating a first message for the first sound;
displaying the first message at a first position on a heads-up display of the AR device, the first position corresponding to a location of the first sound source in a field-of-view of a user as seen through the heads-up display so that the first message is displayed adjacent to the first sound source in the field-of-view; and
updating the first position of the first message on the heads-up display based on a movement of the first sound source and/or the AR device so that the first message tracks the location of the first sound source relative to the heads-up display.

2. The method according to claim 1, further comprising:
capturing a second sound from a second sound source;
determining an identity of the second sound source;
mapping a location of the second sound source;
generating a second message for the second sound;
displaying the second message at a second position on the heads-up display of the AR device, the second position corresponding to a location of the second sound source as seen through the heads-up display; and
updating the second position of the second message on the heads-up display based on the movement of the second sound source and/or the AR device so that the second message tracks the location of the second sound source relative to the heads-up display.

3. The method according to claim 1, wherein determining the identity of the first sound source includes:
capturing, by the AR device, an image of a face at, or near, the location of the first sound source; and
applying the image of the face to a local, or cloud, database of familiar faces to identify the first sound source.

4. The method according to claim 1, wherein determining the identity of the first sound source includes:
detecting, by the AR device, a voice print at or near the location of the first sound source; and
applying the voice print to a local or cloud database of familiar voiceprints to identify the first sound source.

5. The method according to claim 1, wherein determining the identity of the first sound source includes:
capturing, by the AR device, a cloud anchor at or near the location of the first sound source, the cloud anchor identifying the first sound source as an object.

6. The method according to claim 1, wherein determining the identity of the first sound source includes:
capturing, by the AR device, a network identifier of a device at or near the location of the first sound source, the network identifier identifying the first sound source as a device.

7. The method according to claim 1, wherein mapping a location of the first sound source includes:
capturing, by a microphone array of the AR device, signals of the first sound; and
computing a direction for the first sound based on the signals.

8. The method according to claim 1, wherein mapping a location of the first sound source includes:
capturing, by a depth sensor of the AR device, a depth image of the first sound source; and
computing a range to the first sound source based on the depth image.

9. The method according to claim 1, wherein mapping a location of the first sound source includes:
capturing, by a wireless module of the AR device, wireless communication with the first sound source; and
computing a spatial relationship between the first sound source and the AR device based on the wireless communication.

10. The method according to claim 1, wherein mapping a location of the first sound source includes:
gathering localizing data using one or more of a microphone array, a depth sensor; a camera; and a wireless module of the AR device; and
applying the localizing data to a neural network to determine the location of the first sound source.

11. The method according to claim 1, wherein:
the first sound source is a person speaking;
the first message includes a text-to-speech transcript of the person and an identity of the person; and
the first position is adjacent to, but not covering, a face of the person.

12. The method according to claim 1, wherein:
the first message includes an icon pointing in a direction of the of the first sound source when the location of the first sound source in not viewable in the heads-up display.

13. Augmented reality (AR) glasses, comprising:
a microphone array configured for sound localization including capturing sounds from sound sources and determining directions of the sound sources relative to the AR glasses;
a plurality of sensors configured for source localization including determining precise locations of sound source in a global environment based on data from the plurality of sensors;
a heads-up display configured to display messages corresponding to the sounds in a field of view of a user;
an inertial measurement unit configured to measure changes in position of the AR glasses; and
a processor in communication with the microphone array, the heads-up display, and the inertial measurement unit, the processor configured by software to:
generate the messages corresponding to the sounds;
determine locations of the sound sources relative to the AR glasses based on sound localization and source localization when the AR glasses are in a high-power mode;
display the messages on the heads-up display at positions in the field of view corresponding to the locations of the sound sources;
track relative movement of the AR glasses and the sound sources based, at least, on the changes in position of the AR glasses; and
update the positions of the messages as the sound sources or the AR glasses are moved so that each message is virtually anchored to its corresponding sound source.

14. The AR glasses according to claim 13, wherein the plurality of sensors configured for source localization include:
a wireless module configured for ultra-wideband (UWB) wireless communication with an external device, wherein the processor is further configured by software to determine a location of the external device based on the UWB wireless communication.

15. The AR glasses according to claim 13, wherein the plurality of sensors configured for source localization include:
a depth sensor configured to measure a range between a particular sound source and the AR glasses, wherein the processor is further configured by software to determine a location of the particular sound source based on the range.

16. The AR glasses according to claim 13, wherein the plurality of sensors configured for source localization include:
depth camera configured to capture an image of a particular sound source, wherein the processor is further configured by software to determine an identity of the particular sound source based on the image and to include the identity in a corresponding message.

17. The AR glasses according to claim 13, wherein the processor is further configured by software to extract a voice print of a particular sound source and to determine an identity of the particular sound source based on the voice print.

18. The AR glasses according to claim 13, wherein the processor is configured by software to execute a neural network to determine locations of the sound sources, the neural network receiving localizing data from the sound localization and source localization.

19. The AR glasses according to claim 13, wherein the processor is configured by software to filter the relative position of the AR glasses and the sound sources using a Kalman filter to prevent jitter in the positions of the messages as they are updated.

20. The AR glasses according to claim 13, wherein the processor is configured by software to perform maximal Poisson-disk sampling to prevent messages overlapping in the field of view.

21. A method for augmented reality transcription, the method comprising:
transcribing sounds from sound sources in a global environment;
applying sound localization to determine directions for the sounds from the global environment;
applying source localization to determine point locations of the sound sources in the global environment;
generating a source transcript for each sound source based on the directions and the point locations;
generating virtual bounding boxes to contain each sound source based on the sound localization and source localization;
anchoring each source transcript to a point on each of the virtual bounding boxes so that each source transcript appears with a corresponding sound source when viewed through an augmented reality display;
tracking each sound source in the global environment; and
updating a source transcript based on a relative movement of the corresponding sound source.

22. The method for augmented reality transcription according to claim 21, further comprising:
identifying a sound source;
applying source identification to determine identities of one or more sound sources in the global environment; and
modifying source transcripts corresponding to the one or more sound sources based on their determined identity.
